(19) United States
(12) Patent Application Publication
(10) Pub. No.: US 2017/0033342 A1
(43) Pub. Date: Feb. 2, 2017

(54) ELECTRICITY STORAGE DEVICE

(71) Applicant: Sumitomo Electric Industries, Ltd., Osaka-shi (JP)

(72) Inventors: Mitsuyasu Ueda, Itami-shi (JP); Masatoshi Majima, Itami-shi (JP)

(21) Appl. No.: 15/303,182

(22) PCT Filed: Apr. 7, 2015
(86) PCT No.: PCT/JP2015/060818

§ 371 Date: Oct. 10, 2016

(30) Foreign Application Priority Data
Apr. 11, 2014 (JP) 2014-081984

(51) Int. Cl. H01M 2/12; H01M 2/36; H01M 2/04; H01G 11/80; H01G 11/28; H01G 11/24; H01G 11/62; H01M 10/0525; H01G 11/52

(52) U.S. Cl. CPC H01M 2/1241; H01M 10/0525; H01M 2/36; H01M 2/0473; H01G 11/52; H01G 11/28; H01G 11/24; H01G 11/62; H01G 11/80; H01M 2200/20

(57) ABSTRACT

An electricity storage device includes: an electrode group that includes a first electrode, a second electrode, and a separator electrically insulating the first electrode from the second electrode; an electrolyte; a case that accommodates the electrode group and the electrolyte and has an opening; and a sealing plate that seals the opening of the case. The sealing plate has a degassing valve. The degassing valve has a circular easily breakable part. The easily breakable part has a linear first groove, a linear second groove, and a linear third groove. Firs(ends of the first groove, the second groove, and the third groove meet at the Center of the easily breakable part.

### TECHNICAL FIELD

The present invention relates to an electricity storage device including an electrode group that includes a first electrode, a second electrode, and a separator interposed therebetween. More particularly, the present invention relates to an improved technique for reducing the pressure inside a case that accommodates the electrode group when the pressure inside the case abnormally increases.

### BACKGROUND ART

In recent years, electricity storage devices for use in personal digital assistants, electric vehicles, and domestic energy storage systems have been developed. Among electricity storage devices, capacitors and nonaqueous electrolyte secondary batteries have been intensively studied. In particular, lithium ion capacitors are expected to be developed as electricity storage devices that are highly safe and have high capacity and high energy density.

Such an electricity storage device includes an electrolyte and an electrode group that includes a first electrode, a second electrode, and a separator interposed therebetween. Each electrode includes a current collector (electrode core) and an active material carried by the current collector. When an electricity storage device has a prismatic case, an opening of the case is normally sealed with a sealing plate having an external terminal of at least one electrode (see PTLs 1 to 3).

As electricity storage devices have larger volume energy density, there is a greater need for electricity storage devices to have a mechanism for ensuring their safety. One of mechanisms for ensuring the safety of electricity storage devices is a degassing valve that operates when the pressure inside the case abnormally increases. When the degassing valve operates, gas inside the case is released to the outside and the pressure inside the case decreases accordingly.

### CITATION LIST

### Patent Literature

PTL 1: Japanese Unexamined Patent Application Publication No. 2012-109219

PTL 2: Japanese Unexamined Patent Application Publication No. 2011-181485

PTL 3: Japanese Unexamined Patent Application Publication No. 2011-204469

### SUMMARY OF INVENTION

### Technical Problem

A degassing valve is desirably provided on a seating plate particularly in electricity storage devices having a prismatic case (hereinafter may be referred to as prismatic electricity storage devices). Compared with cylindrical devices, prismatic electricity storage devices are advantageous in that the volume of a gap between cases can be reduced when plural devices are assembled and used by connecting these devices in series and/or in parallel. However, when prismatic electricity storage devices having a degassing valve on the lateral side of the case are assembled and used, the degassing valve may be closed by another device. Providing the degassing valve on the sealing plate can easily prevent the degassing valve from being closed by another device and allows the degassing valve to always operate effectively.

However, with the trend toward high energy density, there is a need for small, thin prismatic electricity storage devices in order to increase the degree of freedom of arrangement. When such a prismatic electricity storage device is made thin to meet this requirement, the pressure distribution in the case tends to be uneven. Thus, the degassing valve fails to operate stably unless a variation in the operating pressure of the degassing valve is reduced. The operating pressure of the degassing valve is a pressure actually applied to the degassing valve or the sealing plate when the degassing valve operates. The operating pressure of the degassing valve often differs from, for example, the average pressure inside the case of an electricity storage device.

### Solution to Problem

According to an aspect of the present invention, an electricity storage device includes

an electrode group that includes a first electrode, a second electrode, and a separator electrically insulating the first electrode from the second electrode,

an electrolyte,

a case that accommodates the electrode group and the electrolyte and has an opening, and

a sealing plate that seals the opening of the case,

wherein

the first electrode includes a first current collector having a sheet shape and a first active material carried by the first current collector,

the second electrode includes a second current collector having a sheet shape and a second active material carried by the second current collector,

the first electrode and the second electrode are alternately stacked with the separator interposed therebetween,

the sealing plate has a degassing valve through which gas in the case is to be released to the outside when the pressure that the sealing plate receives from the gas in the case reaches a reference pressure,

the degassing valve has a thin, circular easily breakable part, and the easily breakable part has a linear first groove, a linear second groove, and a linear third groove, and

first ends of the first groove, the second groove, and the third groove meet at the center of the easily breakable part.

### Advantageous Effects of Invention

According the foregoing, a variation in the operating pressure of the degassing valve can be reduced. Because of this, the degassing valve can be operated at an appropriate time, and the safety of the electricity storage device can he improved,

### BRIEF DESCRIPTION OF DRAWINGS

FIG. 1 is a perspective view of the appearance of an electricity storage device according to an embodiment of the present invention,

FIG. 2 is a partial cross-sectional view of the internal structure of the electricity storage device as viewed from the front.

FIG. 3A is a partial cross-sectional view taken along line IIIA-IIIA in FIG. 2.

FIG. 3B is a partial cross-sectional view taken along line IIIB-IIIB in FIG. 2.

FIG. 4 is a top view of a sealing plate that seals the opening of a case of the electricity storage device.

FIG. 5 is a partial cross-sectional view of the sealing plate illustrating the detailed structure of a degassing valve.

FIG. 6 is a schematic diagram illustrating an example partial structure of the skeleton of a first current collector.

FIG. 7 is a cross-sectional schematic diagram illustrating a state in which the first current collector is filled with an electrode mixture.

FIG. 8 is a partial cross-sectional view of the sealing plate illustrating problems of a conventional degassing valve.

### DESCRIPTION OF EMBODIMENTS

### Overview of Embodiments of Present Invention

An electricity storage device according to an aspect of the present invention includes: an electrode group that includes plural first electrodes, plural second electrodes, and one or more separators electrically insulating the plural first electrodes from the plural second electrodes; an electrolyte; a case that accommodates the electrode group and the electrolyte and has an opening; and a sealing plate that seals the opening of the case. The first electrodes each include a first current collector having a sheet shape and a first active material carried by the first current collector. The second electrodes each include a second current collector having a sheet Shape and a second active material carried by the second current collector. The first electrodes and the second electrodes are alternately stacked with the separators each interposed therebetween.

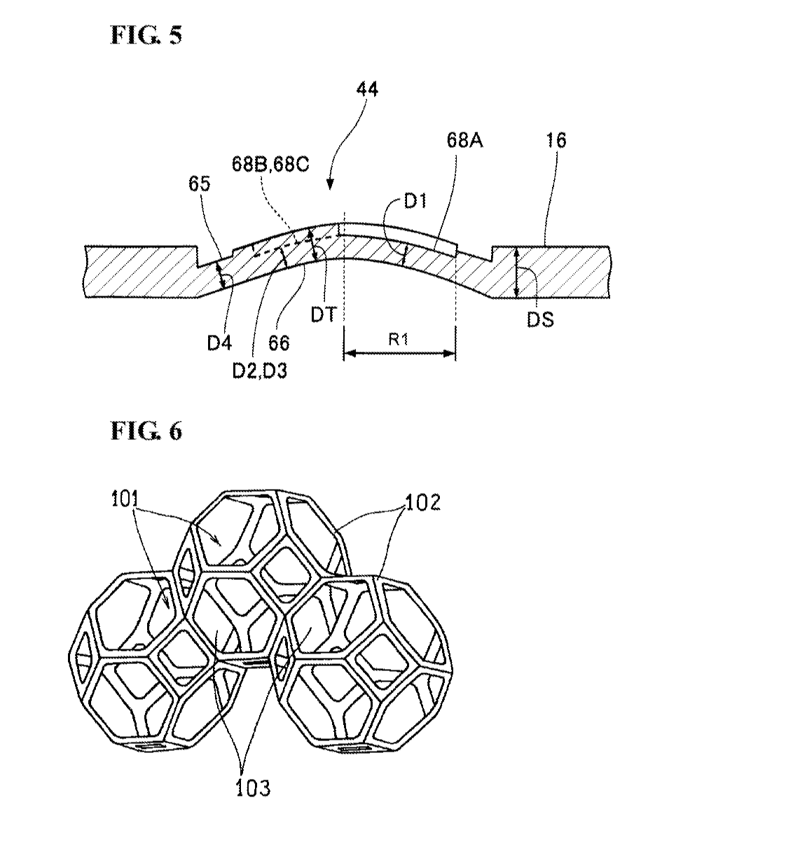

The sealing plate has a degassing valve through which gas in the case is to be released to the outside when the pressure that the sealing plate receives from the gas in the case reaches a reference pressure. The degassing valve has a circular easily breakable part. The easily breakable part has a linear first groove, a linear second groove, and a linear third groove. First ends of the first groove, the second groove, and the third groove meet at the center of the easily breakable part (see FIGS. 4 and 5). In other words, the first ends of the first groove, the second groove, and the third groove are located at the center of the easily breakable part.

The easily breakable part is preferably thin. That is, the thickness DT of the easily breakable part (see FIG. 5) may be equal to or larger than the thickness of the surrounding area (the thickness DS of the sealing plate), but the thickness DT of the easily breakable part is preferably smaller than the thickness of the surrounding area (the thickness DS of the sealing plate). For example, it is preferable that t>DT/DS≧0.2, and more preferable that 0.8≧DT/DS≧0.4.

In this embodiment, any one of the angle formed by the first groove and the second groove, the angle formed by the second groove and the third groove, and the angle formed by the third groove and the first groove may be 180°.

In the degassing valve in this embodiment, the plural grooves are formed in the easily breakable part. As a result, the thicknesses of portions where the plural grooves are formed are further reduced. The plural grooves are each linear and disposed so as to form a Y-character in the easily breakable part. The easily breakable part and the plural grooves can be formed on the sealing plate, for example, by using a stamp. Alternatively, the degassing valve may be provided on the sealing plate by preparing a member having an easily breakable part and plural grooves and bonding (or welding) the periphery of the member to the opening end of a through-hole in the scaling plate.

The easily breakable part is provided on the sealing plate, and plural grooves arranged in a Y-character shape are formed in the easily breakable part. As a result, the residual thickness of portions having the plural grooves is further reduced. This configuration allows the easily breakable part to easily undergo a break originating from, for example, the plural grooves when the pressure inside the case abnormally increases. Therefore, the pressure inside the case can be readily reduced by releasing the gas inside the case to the outside.

As described above, in the degassing valve in this embodiment, a circular easily breakable part having an appropriate thickness is formed on the sealing plate without directly forming grooves on the sealing plate. Then, plural grooves are formed in the easily breakable part so as to form a Y-character. Because of this, the thickness of the sealing plate can be set to a thickness that can ensure sufficient strength as a sealing plate. The thickness of the easily breakable part and the depth of the plural grooves (or the residual thickness of the easily breakable part) can be appropriately set such that the degassing valve operates under a desired operating pressure. The term “operating pressure” as used herein refers to an actual pressure actually that the easily breakable part receives when the easily breakable part of the degassing valve undergoes a break originating from the plural grooves.

When the average thickness of the sealing plate is increased in order to obtain sufficient strength of the sealing plate, it is difficult to stabilize the operating pressure of the degassing valve only by forming grooves having an appropriate depth on the sealing plate. That is, as shown in FIG. 8, when a difference (D12−D11) between the residual thickness D11 of a portion with the groove 121 and the thickness D12 of the surrounding area (average thickness of the sealing plate) is large in the sealing plate 120, a variation in pressure (variation in operating pressure) at the time of a break of a portion of the scaling plate 120 at the groove 121 is large. When the thickness D12 of a portion around the groove 121 is large and the sealing plate 120 breaks at even a portion at the groove 121, the area of an aperture formed as a result of the break is small and it is difficult to readily reduce the pressure inside the case.

In this embodiment, when the easily breakable part and the grooves arranged in a Y-character shape are formed by, for example, using a stamp, the easily breakable part and the plural grooves can be simultaneously formed by one-press operation. It is also easy to precisely control the thickness of the easily breakable part and the residual thickness at the grooves. Arrangement of the plural grooves in a Y-character shape allows the easily breakable part to assuredly undergo a break originating from any one of the grooves under a desired operating pressure when the pressure inside the case abnormally increases. It is also easy to increase the area of the aperture formed as a result of the break of the easily breakable part. This can reduce the pressure inside the case assuredly and readily.

When four or more grooves are provided, it is easier to assuredly cause a break originating from any one of the grooves in the easily breakable part under a desired operating pressure. However, the more grooves the easily breakable part includes, the smaller regions the easily breakable part may be divided into. Therefore, when the degassing valve actually operates, an aperture with a sufficient area cannot be made in the easily breakable part and the pressure inside the case may not be readily reduced. When the easily breakable part has three grooves arranged in a Y-character shape, the pressure inside the case can be reduced assuredly and readily.

The thickness DT of the easily breakable part can be set according to the material of the sealing plate. For example, when the sealing plate is made of aluminum or an aluminum alloy (e.g., 3000 series or 5000 series aluminum alloys according to the International Alloy Designation System) or contains aluminum or an aluminum alloy, the thickness DT of the easily breakable part is preferably 50 to 250 μm. For example, when the rated capacity of the electricity storage device is 500 or more and less than 1000 mAh, the radius R1 of the easily breakable part is preferably 2 to 4 mm. When the rated capacity or the electricity storage device is 1000 to 3000 mAh, the radius of the easily breakable part is preferably 3 to 6 mm.

The ratios L1/R1, L2/R1, and L3/R1, which are ratios of the length L1 of the first groove, the length L2 of the second groove, and the length L3 of the third groove to the radius R1 of the circular easily breakable part, is preferably 0.98 to 1.02. With the ratios L1/R1, L2/R1, and L3/R1 in this range, a variation in the operating pressure of the degassing valve can be reduced.

Second ends of the plural grooves preferably reach the periphery of the circular easily breakable part. This structure makes it easy to reduce a variation in the operating pressure of the degassing valve, and to sufficiently increase the area of the aperture formed as a result of the break of the easily breakable part. It is noted that the lengths L1, L2, and L3 and the radius R1 are lengths in the projection view of the sealing plate as viewed from above.

As long as the ratios L1/R1, L2/R1, and L3/R1 are in the range of 0.98 to 1.02, the first ends of the plural grooves may be deviated from the center. However, the first ends of all the grooves preferably coincide with the center of the circular easily breakable part.

Moreover, the ratio D1/D2 of a residual thickness D1 of the easily breakable part at the first groove to a residual thickness D2 of the easily breakable part at the second groove, the ratio D2/D3 of the residual thickness D2 of the easily breakable part at the second groove to a residual thickness D3 of the easily breakable part at the third groove, and the ratio D3/D1 of the residual thickness D3 of the easily breakable part at the third groove to the residual thickness D1 of the easily breakable part at the first groove are preferably 0.98 to 1.02. That is, the depths of the plural grooves are preferably the same or substantially the same. With such depths, a variation in the operating pressure of the degassing valve can be effectively reduced. For the same reason, the depth of each groove is preferably as uniform as possible in the extending direction of the groove. For the same reason, the obtuse angle θ1 formed by the first groove and the second groove, the obtuse angle θ2 formed by the second groove and the third groove, and the obtuse angle θ3 formed by the third groove and the first groove are preferably (120×0.98)° to (120×1.02)°. It is noted that the sum of θ1, θ2, and θ3 is 360° (θ1+θ2+θ3=360°).

When the sealing plate has a pair of parallel long sides and a pair of parallel short sides, any one of the first groove, the second groove, or the third groove is preferably parallel to the pair of long sides and is located in the middle between the pair of long sides. With this configuration, it is easy to stably break at least a groove (e.g., first groove) disposed parallel to the long sides of the sealing plate under a desired operating pressure even in a flat battery case having, for example, an aspect ratio α1 of 5 to 15. This is because, in the electricity storage device having a flat prismatic shape, the pressure that the sealing plate receives from the gas inside the case causes the maximum stress to be generated along the groove (e.g., first groove) disposed parallel to the long sides of the scaling plate. This reduces a variation in the operating pressure of the degassing valve in the electricity storage device having a flat prismatic shape. It is noted that α1 is an aspect ratio of the battery as viewed from directly above, that is, the ratio W2/W1 of a distance W2 between the pair of short sides to a distance W1 between the pair of long sides of the sealing plate.

Furthermore, in the electricity storage device in this embodiment, the degassing valve preferably has, around the easily breakable part, a break propagation preventing part for preventing a break of the easily breakable part from propagating around the easily breakable part when the easily breakable part undergoes a break originating from, for example, the first groove, the second groove, and the third groove. Because of this configuration, the break of the easily breakable part originating from the first groove, the second groove, and the third groove stays inside the easily breakable part, so that the degassing valve can stably operate. The break propagation preventing part may be an annular groove or a linear groove.

When the sealing plate has a circular injection hole for injecting an electrolyte into the case after sealing the opening of the case, it is preferred that the center or the easily breakable part be located in the middle between the pair of long sides of the sealing plate and in the middle between the pair of short sides, and the ratio LS/DS of the shortest distance LS between the break propagation preventing part and the injection hole to the thickness DS of the sealing plate be preferably 5 to 12. In evaluating the ratio LS/DS of the shortest distance LS to the thickness DS, the thickness DS can be regarded as the average thickness of the sealing plate between the break propagation preventing part and the injection hole.

When the center of the easily breakable part is located in the middle between the pair of long sides and the pair of short sides of the sealing plate, the degassing valve can be operated properly in accordance with an increase in pressure inside the ease. However, when the sealing plate is provided with the injection hole and an electrolyte is injected into the case after sealing the opening of the case with the sealing plate, the injection hole is also preferably located as close as possible to the middle or the sealing plate. This allows the electrode group to be successfully impregnated with the electrolyte. Therefore, in such a case, the injection hole and the degassing valve located in the middle of the sealing plate are preferably disposed as close as possible to each other.

However, when the injection hole and the degassing valve are located too close to each other, the presence of the injection hole may make the operating pressure of the degassing valve unstable. When the shortest distance LS between the break propagation preventing part and the injection hole and the thickness DS of the sealing plate are set such that the ratio LS/DS is in the above range, the degassing valve can be operated properly in accordance with an increase in pressure inside the case. As a result, the electrode group can be uniformly impregnated with the electrolyte in impregnating the electrode group with the electrolyte.

In an embodiment of the electricity storage device as a lithium ion capacitor, an electrolyte contains a salt of a lithium ion and an anion, any one of a first active material and a second active material is a first material (negative electrode active material) that intercalates and deintercalates the lit hi urn ion, and the other active material is a second material (positive electrode active material) that adsorbs and desorbs the anion. The first material intercalates and deintercalates the lithium ion by the Faradaic reaction. Examples of the first materials include carbon materials, such as graphite, and alloy active materials with Si, SiO, Sn, SnO, and the like. The second material adsorbs and desorbs the anion by the non-Faradaic reaction. Examples of the second material include carbon materials, such as activated carbon and carbon nanotubes. The second material (positive electrode active material) may be a material that involves the Faradaic reaction. Examples of such a material include metal oxides, such as manganese oxide, ruthenium oxide, and nickel oxide, and conductive polymers, such as polyacene, polyaniline, polythiol, and polythiophene. A capacitor in which the first material and the second material both involve the Faradaic reaction is referred to as a redox capacitor.

The first current collector preferably includes a first metal porous body. For example, when the first electrode is a positive electrode of a lithium ion capacitor, a metal porous body containing aluminum is preferably used in the first current collector. When the first electrode is a negative electrode of a lithium ion capacitor, a metal porous body containing copper is preferably used in the first current collector.

In order to increase the capacity of the electricity storage device, the amount (per unit area) of the active material carried by the current collector is desirably increased as much as possible. However, when a large amount of the active material is carried by a conventional current collector made of metal foil, an active material layer is thick and the average distance between the active material and the current collector is large. As a result, the electrode has low current collecting performance, and the contact between the active material and the electrolyte is limited, which makes it easy to impair charge/discharge characteristics.

A metal porous body having communicating pores and high porosity is preferably used as the current collector. The metal porous body is produced by, for example, the following procedure: forming a metal layer on the skeleton surface of a foamed resin having communicating pores, such as foamed urethane; then thermally decomposing the foamed resin: and further reducing the Metal.

In addition, a plurality of the first current collectors each preferably have a tab-shaped first connection part for electrically connecting adjacent first current collectors. The first connection parts of the plural first current collectors are disposed so as to overlap one another in the stacking direction of the electrode group, and are preferably fastened together by a first fastening member.

The second current collector can also include a second metal porous body. In addition, a plurality of the second current collectors each may be provided with a tab-shaped second connection part for electrically connecting adjacent second current collectors. These second connection parts can be disposed so as to overlap one another in the stacking direction of the electrode group, and can be fastened together by a second fastening member.

The first metal porous body and the second metal porous body have a porous structure whose surface area for carrying an active material (hereinafter referred to as an effective surface area) is larger than that of simple metal foil or the like. From such a viewpoint, the first metal porous body and the second metal porous body are most preferably a metal porous body having a three-dimensional network and a hollow skeleton, such as Celmet (registered trademark, available from Sumitomo Electric Industries, Ltd.) or Aluminum-Celmet (registered trademark, available from Sumitomo Electric Industries, Ltd.) described below because the effective surface area per unit volume can be significantly increased. In addition, the first metal porous body and the second metal porous body may be made of non-woven fabric, punched metal, expanded metal, or the like. The non-woven fabric, Celmet, and Aluminum-Celmet are porous bodies having a three-dimensional structure. The punched metal and expanded metal are porous bodies having a two-dimensional structure.

The metal porous bodies as described above are considered suitable as electrodes for electricity storage devices because such metal porous bodies can carry a large amount of an active material because of a large surface area, and tend to hold an electrolyte. When plural electrodes having the same polarity and each including a metal porous body as a current collector are used, the current collectors having the same polarity are connected in parallel.

### Detailed Description of Embodiments of Present Invention

A detailed description of embodiments of the present invention will be provided below with reference to the drawings. The present invention is not limited to these examples. The scope of the present invention is indicated by the attached claims and is intended to include all modifications within the meaning and range of equivalency of the claims.

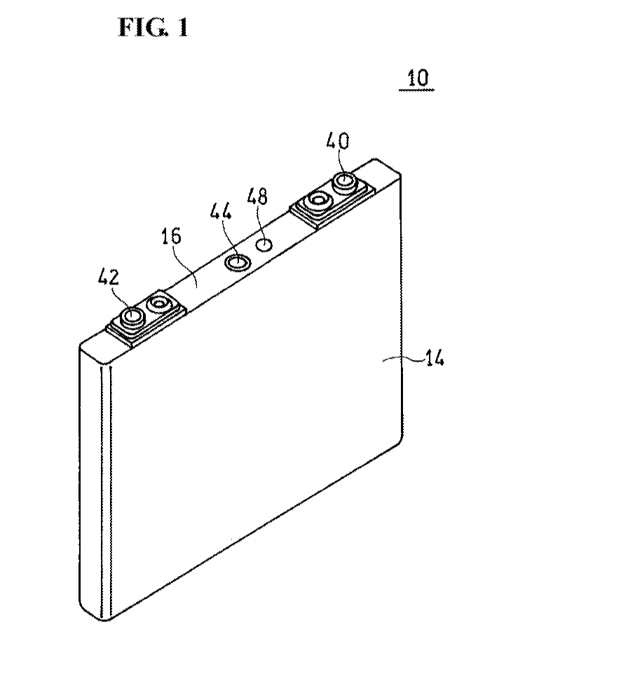

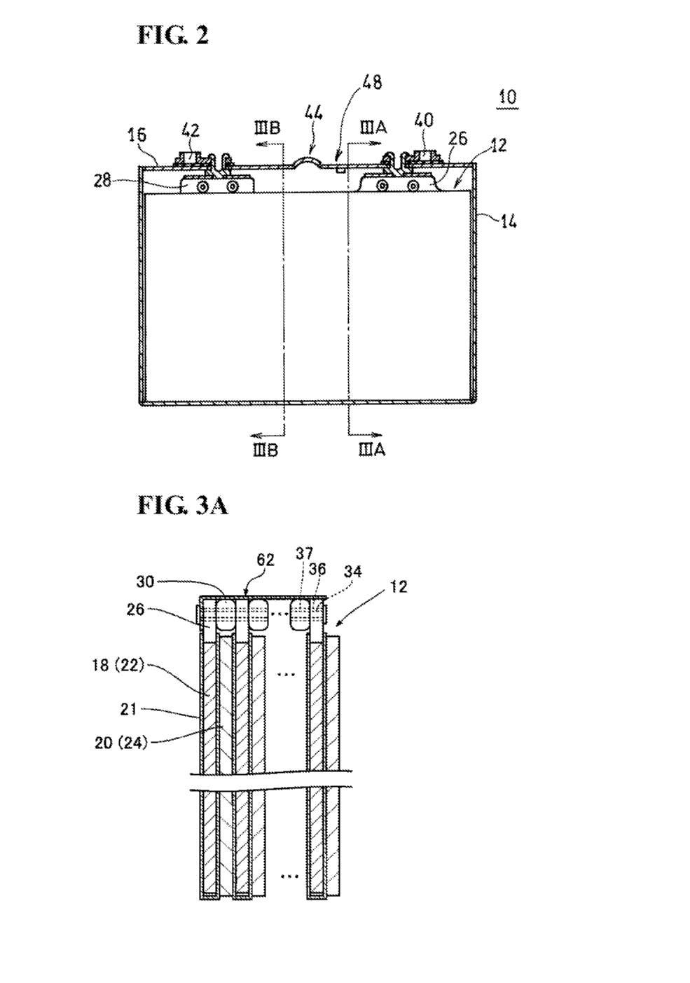

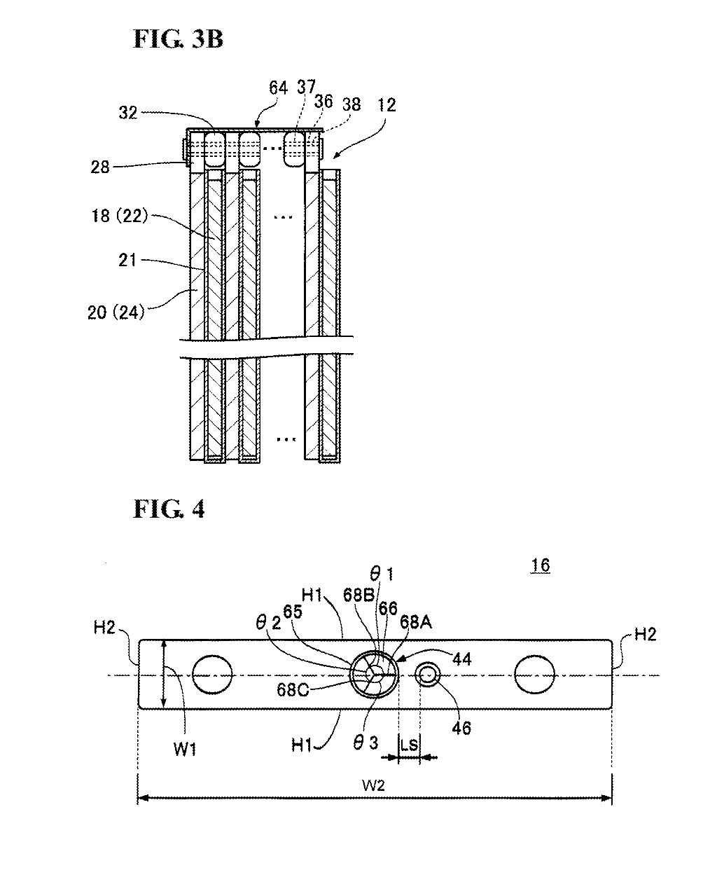

FIG. 1 is a perspective view of the appearance of an electricity storage device according to this embodiment FIG. 2 is a partial cross-sectional view of the internal structure of the electricity storage device as viewed from the front. FIGS. 3A and 3B are cross-sectional views taken along line IIIA-IIIA and line IIIB-IIIB in FIG. 2, respectively.

An electricity storage device 10 in an illustrated example is, for example, a lithium ion capacitor. The electricity storage device 10 includes an electrode group 12, a case 14 that accommodates the electrode group 12 and an electrolyte (not illustrated), and a sealing plate 16 that seals an opening of the case 14. In the illustrated example, the ease 14 has a prismatic shape. The embodiments of the present invention can be most suitably applied to a prismatic case as in the illustrated example.

As shown in FIG. 3A and FIG. 3B, the electrode group 12 includes plural sheet-shaped first electrodes 18 and plural sheet-shaped second electrodes 20. The first electrodes 18 and the second electrodes 20 are alternately stacked with sheet-shaped separators 21 each interposed therebetween. The first electrodes 18 each include a first current collector 22 and a first active material. The second electrodes 20 each include a second current collector 24 and a second active material.

Either the first electrodes 18 or the second electrodes 20 are positive electrodes, and the other electrodes are negative electrodes. The positive electrodes each include a positive electrode current collector and a positive electrode active material. The negative electrodes each include a negative electrode current collector and a negative electrode active material. Either the first current collector 22 or the second current collector 24 is a positive electrode current collector, and the other current collector is a negative electrode current collector. In FIG. 3A and FIG. 3B, the first electrodes 18 are illustrated as positive electrodes, and the second electrodes 20 are illustrated as negative electrodes for easy understanding of the invention. That is, the first current collector 22 is a positive electrode current collector, and the second current collector 24 is a negative electrode current collector. In FIG. 3A and FIG. 3B, the electrodes and the current collectors are illustrated as the same components because it is difficult to illustrate the electrodes and the current collectors to be distinguishable from each other.

The first current collector 22 (positive electrode current collector) includes a first metal porous body, and the second current collector 24 (negative electrode, current collector), includes a second metal porous body. At this time, a first metal is preferably aluminum or an aluminum alloy, and a second metal is preferably copper or a copper alloy. The thickness of the positive electrode current collector is preferably 0.1 to 10 mm. The thickness of the negative electrode current collector is preferably 0.1 to 10 mm.

Since Aluminum-Celmet (registered trademark, available from Sumitomo Electric Industries, Ltd.) has large porosity (e.g., 90% or more) and continuous pores and contains few closed pores, Aluminum-Celmet is particularly preferred as the first current collector 22 (positive electrode current collector). For the same reason, Celmet containing copper or nickel (registered trademark, available from Sumitomo Electric Industries, Ltd.) is particularly preferred as the second current collector 24 (negative electrode current collector). Celmet or Aluminum-Celmet will be described below in detail.

The first current collector 22 has a tab-shaped first connection part 26. Similarly, the second current collector 24 can be provided with a tab-shaped second connection part 28. Each connection part is preferably made of the same material as the body of the current collector and is preferably integrated with the body. Each of first conductive spacers 30 is disposed between the first connection parts 26 of the plural first current collectors 22. Similarly, each of second conductive spacers 32 can also he disposed between the second connection parts 28 of the plural second current collectors 24.

Although not limited, the percentage of the project area of the first connection part 26 (area as viewed in a direction perpendicular to the main surface of the first current collector) with respect to the project area of the entire first current collector 22 can be 0.1% to 10%. Alternatively, the project area of the first connection part 26, or the length of the boundary between the body of the first current collector and the first connection part may be determined according to the capacity of the electricity storage device. The boundary is, for example, a straight line coaxial with a side of the first current collector provided with the first connection part. The first connection part 26 may have a rectangular shape with rounded corners, hut is not limited to such a shape.

The first conductive spacer 30 can be formed of a plate-shaped member containing a conductor (e.g., a metal or a carbon material). In order to increase adhesion with the first connection part 26, the first conductive spacer 30 is preferably formed of a metal porous body (third metal porous body), and particularly preferably formed of the same material (e.g., Aluminum-Celmet) as the first current collector 22. Similarly, the second conductive spacer can also be formed of a plate-shaped member containing a conductor (e.g., a metal or a carbon material). The second conductive spacer 32 is also preferably formed of a metal porous body (fourth metal porous body), and particularly preferably formed of the same material (e.g., Celmet containing copper) as the second current collector 24.

The separator 21 preferably has a bag shape so as to contain the first electrode 18 (positive electrode). The bag-shaped separator 21 can be formed by, for example, folding a rectangular separator 21 along the lengthwise centerline, and sticking (welding) marginal parts together except for parts corresponding to the opening.

The first connection parts 26 of the first electrodes 18 may include, for example, a through-hole 36 for receiving a first fastening member 34, which is a rivet. Any number of through-holes 36 may be provided. Each first connection part 26 is formed near one end of the side of the first current collector 22 provided with the first connection part 26. Similarly, the second connection parts 28 of the second electrodes 20 may include a through-hole 36 for receiving a second fastening member 38, which is a rivet. Each second connection part 28 is formed near the other end of the side of the second current collector 24 provided with the second connection part 28. The first conductive spacers 30 may also include a through-hole 37 for receiving the first fastening member 34 at the position corresponding to the through-hole 36 in each first connection part 26. The second conductive spacers 32 may also include a through-hole 37 for receiving the second fastening member 38 at the position corresponding to the through-hole 36 in each second connection part 28. With the first fastening member 34 one end of a first lead 62 is attached to the electrode group 12 so as to contact one of the first connection parts 26. With the second fastening member 38, one end of a second lead 64 is attached to the electrode group 12 so as to contact one of the second connection parts 28.

Thus, the first connection parts 26 and the second connection parts 28 are substantially symmetrically disposed when the first electrodes 18 and the second electrodes 20 are stacked. When each second electrode 20 is a negative electrode, the external shape of the body of the second electrode 20 (second current collector 24) is formed to have substantially the same size as the external shape of the bag-shaped separator 21. That is, the external shape of the negative electrode is larger than the external shape of the positive electrode. Consequently, the entire positive electrode can face the negative electrode with the separator therebetween.

The first fastening member 34 is preferably formed of the same conductive material as the first current collector 22. This is because the corrosion resistance of the first fastening member 34 is increased. Similarly, the second fastening member 38 is also preferably formed of the same conductive material as the second current collector 24.

Since the First connection parts 26 of the plural first electrodes 18 are disposed so as to overlap one another in the stacking direction of the electrode group 12, the through-holes 36 in the first connection parts 26 are also aligned. The first conductive spacers 30 arc also disposed such that the through-holes 37 are aligned with the corresponding through-holes 36. The first fastening member 34 is inserted into the aligned through-holes 36 and 37, and the plural first connection parts 26 are fastened together by riveting the ends (heads) of the first fastening members 34 to the first connection parts 26 or the like. Similarly, the plural second connection parts 28 are also fastened together by the second fastening members 38 inserted into the aligned through-holes 36 and 37.

The scaling plate 16 has a first external terminal 40 electrically connected to the plural first electrodes 18 and a second external terminal 42 electrically connected to the plural second electrodes 20. A degassing valve 44 is provided in a middle portion of the scaling plate 16, and a plug 48 for closing an injection hole 46 (see FIG. 4) is provided at a position closer to the first external terminal 40.

FIG. 4 is a top view of the sealing plate. FIG. 5 is a partial cross-sectional view of the sealing plate illustrating the detailed structure of the degassing valve. The sealing plate 16 has a rectangular shape with a pair of long sides 111, a pair of short sides 112, and rounded corners. The degassing valve 44 has a circular easily breakable part 66, a linear first groove 68A, a linear second groove 68B, and a linear third groove 68C. The first groove 68A, the second groove 68B, and the third groove 68C are formed in the easily breakable part 66. First ends of the first groove 68A, the second groove 68B, and the third groove 68C meet at the center of the easily breakable part 66.

The sealing plate 16 has a break propagation preventing part 65, which is an annular groove, along the periphery of the circular easily breakable part 66. Second ends of the first groove 68A, the second groove 68B, and the third groove 68C reach the break propagation preventing part 65. Therefore, the lengths L1, L2, and L3 (lengths in the plane direction of the sealing plate 16) of the first groove 68A, the second groove 68B, and the third groove 68C are equal to or substantially equal to the radius RI of the easily breakable part 66. In other words, the ratios L1/R1, L2/R1, and L3/R1 are values in the range of 0.98 to 1.02.

The obtuse angle 01 formed by the first groove and the second groove, the obtuse angle θ2 formed by the second groove and the third groove, and the obtuse angle θ3 formed by the third groove and the first groove are angles in the range of (120×0.98)° to (120×1.02)° (angles in the range of 117.6° to 122.4°). It is noted that the sum of θ1, θ2, and θ3 is 360° (θ1+θ2+θ3=360°). When the plural grooves, the easily breakable part 66, and the break propagation preventing part 65 are formed on the sealing plate 16 by using a stamp or the like, the easily breakable part preferably rises in a dome shape as shown in FIG. 5.

The center of the easily breakable part 66 is located in the middle between a pair of long sides H1 and in the middle between a pair of short sides H2. That is, the degassing valve 44 is located in a middle portion of the sealing plate 16. When the degassing valve 44 is provided in the middle portion of the sealing plate 16, the degassing valve 44 can be operated by accurately detecting an increase in pressure inside the case.

The thickness DT of the easily breakable part 66 can be set according to the operating pressure of the degassing valve 44 and the material of the sealing plate. For example, when the operating pressure is 0.1 MPa to 5 MPa, and the sealing plate is made of aluminum or an aluminum alloy (e.g., 3000 series or 5000 series aluminum alloys according to the International Alloy Designation System) or contains aluminum or an aluminum alloy, the thickness DT of the easily breakable part 66 is preferably 50 to 250 μm. The radius R1 of the easily breakable part is preferably 2 to 4 mm when the rated capacity of the electricity storage device is 500 or more and less than 1000 mAh, and is preferably 3 to 6 mm when the rated capacity of the electricity storage device is 1000 to 3000 mAh.

The ratio D1/D2 of a residual thickness D1 of the easily breakable part 66 at the first groove 68A to a residual thickness D2 of the easily breakable part 66 at the second groove 68B, the ratio D2/D3 of the residual thickness D2 of the easily breakable part at the second groove 68B to a residual thickness D3 of the easily breakable part at the third groove 68C, and the ratio D3/D1 of the residual thickness D3 of the easily breakable part at the third groove 68C to the residual thickness D1 of the easily breakable part at the first groove 68A are values in the range of 0.98 to 1.02. That is, the residual thickness D1 of the easily breakable part 66 at the first groove 68A, the residual thickness D2 of the easily breakable part at the second groove 68B, and the residual thickness D3 of the easily breakable part at the third groove 68C are the same or substantially the same.

The residual thicknesses D1, D2, and D3 at the grooves can be set according to the material or the sealing plate. For example, when the sealing plate is made of aluminum or an aluminum alloy, or when the sealing plate contains aluminum or an aluminum alloy, the residual thicknesses D1, D2, and D3 at the grooves are preferably 10 to 100 μm. The residual thickness D4 of the sealing plate in the break propagation preventing part 65 is larger than all the residual thicknesses D1, D2, and D3, (D4>D1, D4>D2, D4>D3). By making all the residual thicknesses D1, D2, and D3 at the grooves smaller than the residual thickness D4 of the break propagation preventing part, the easily breakable part 66 is allowed to break along each groove earlier than the break propagation preventing part 65. When the break propagation preventing part 65, which is an annular groove, is provided adjacent to the easily breakable part 66 and around the easily breakable part 66, the easily breakable part 66 or the sealing plate 16 tends to bend along the break propagation preventing part 65 at the time of the break of the easily breakable part 66 along each groove. This easily increases the effective area of an aperture formed as a result of the break of the easily breakable part 66. Therefore, the gas inside the case can be readily discharged from the ease.

One groove (first groove 68A in the illustrated example) among the plural grooves is parallel to the pair of long sides H1 of the sealing plate 16 and is located in the middle between the pair of long sides H1. Forming the first groove 68A in such a position makes it easy to stably break at least the first groove 68A under a desired pressure even when the electricity storage device is flat and the aspect ratio α1, W2/W1, of the case 14 is 5 to 15. This also sufficiently reduces a variation in the operating pressure of the degassing valve 44 in the electricity storage device having the flat case 14 as described above.

The sealing plate 16 has an injection hole 46 for injecting an electrolyte into the case 14 after sealing the opening of the case 14. The injection hole 46 is located near the degassing valve 44 of the sealing plate 16. In order to achieve successful electrolyte impregnation when the electrolyte is injected into the case 14, the injection hole 46 is preferably located as close as possible to a middle portion of the sealing plate. In order to operate the degassing valve (breakable valve) at an appropriate time in accordance with an increase in pressure inside the case, the degassing valve 44 is preferably disposed in the middle portion of the sealing plate 16.

In order to stabilize the operating pressure of the degassing valve 44, the injection hole 46 and the degassing valve 44 are preferably disposed with a certain distance.

From the above reasons, the ratio LS/DS of the shortest distance LS between the break propagation preventing part 65 and the injection hole 46 to the thickness DS of the sealing plate 16 is preferably 5 to 12. In evaluating the ratio LS/DS of the shortest distance LS to the thickness DS, the thickness DS can be regarded as the average thickness of the sealing plate 16 between the break propagation preventing part 65 and the injection hole 46, except a recess around the injection hole 46 or the like.

Next, the metal porous body used as the first current collector 22 or the second current collector 24 will be described in detail.

The metal porous body preferably has a three-dimensional network and a hollow skeleton. When the skeleton has an empty space inside, the metal porous body has a bulky three-dimensional structure and is very lightweight.

The metal porous body can be formed by the following procedure: plating a resin porous body having continuous voids with a metal for forming the collector and decomposing or dissolving the resin inside by a heat treatment. The plating process forms a three-dimensional network skeleton, and the decomposition and dissolution of the resin forms a hollow skeleton.

The resin porous body is made of any resin material that has continuous voids, and a resin foamed body, a resin non-woven fabric, or the like can be used. After the heat treatment, components remaining in the skeleton (resin, decomposed products, unreacted monomers, and additives included in the resin) may be removed by washing or the like.

Examples of the resin that forms the resin porous body include thermosetting resins, such as thermosetting polyurethane and melamine resin; and thermoplastic resins, such as olefin resins (e.g., polyethylene, polypropylene) and thermoplastic polyurethane. When a resin foamed body is used, individual pores formed in the foamed body are cell-like pores (individual pores may not be cell-like pores depending on the type of resin or the method for producing the foamed body). The cells are connected and communicate with each other to form continuous voids. Such a foamed body contains small cell-like pores, and the size of the pores tends to be uniform. In particular, when thermosetting polyurethane or the like is used, the size and shape of pores tend to be more uniform.

The plating process can be performed by a publicly known plating method, for example, an electroplating method, or a molten-salt plating method because such a method can form a metal layer that functions as a current collector on the surface of the resin porous body (including the surfaces in the continuous voids). The plating process Forms a metal porous body having a three-dimensional network according to the shape of the resin porous body. When the plating process is performed by an electroplating method, a conductive layer is desirably formed before electroplating. The conductive layer may be formed on the surface of the resin porous body by, for example, electroless plating, vapor deposition, sputtering as well as application of a conducting agent or the like, or may be formed by immersing the resin porous body in a dispersion containing a conducting agent.

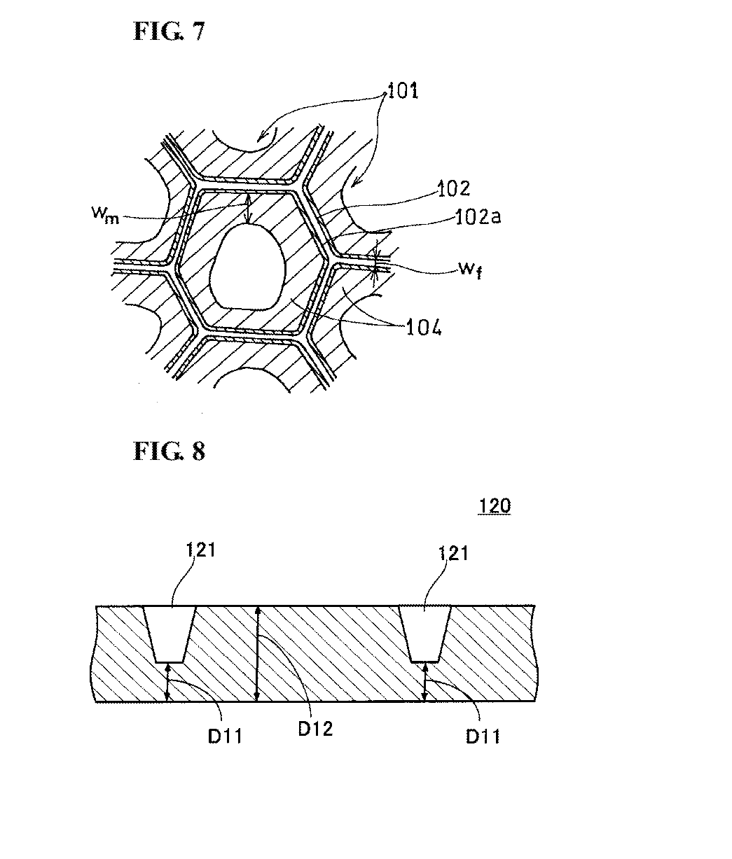

After the plating process, the resin porous body is removed by performing heating, so that an empty space is formed in the skeleton of the metal porous body to make a hollow. The width of the empty space inside the skeleton (width w_{f} of the empty space in FIG. 7 described below) is, for example, 0.5 to 5 μm and preferably 1 to 4 μm or 2 to 3 μm in terms of mean value.

The resin porous body can be removed by a heat treatment with appropriate application of voltage as desired. The heat treatment may be performed by application of voltage while the plated porous body is immersed in a molten-salt plating bath.

The metal porous body has a three-dimensional network structure corresponding to the structure of the resin foamed body. Specifically, the current collector has many pores each having a cell shape. These cell-like pores are connected to each other to form communicating continuous voids. An opening (or window) is formed between adjacent cell-like pores. The pores are preferably in communication with each other through the opening. Examples of the shape of the opening (or window) include, but are not limited to, substantial polygons (substantial triangles, substantial quadrangles, substantial pentagons, and/or substantial hexagons). The term “substantial polygons” as used herein refers to polygons and shapes similar to polygons (e.g., polygons having rounded corners and polygons in which part or all of the sides are curved).

FIG. 6 is a schematic view of the skeleton of the metal porous body. The metal porous body has plural cell-like pores 101 surrounded by a metal skeleton 102. An opening (or window) 103 having a substantially polygonal shape is formed between adjacent pores 101. The opening 103 allows communication between the adjacent pores 101, and the current collector accordingly has continuous voids. The metal skeleton 102 is three-dimensionally formed so as to make cell-like pores and to connect the pores and, as a result, a three-dimensional network structure is formed.

The metal porous body has very high porosity and large specific surface area. That is, a large amount of the active material can be attached to a large area including the surfaces inside the voids. Since the metal porous body has large contact area with the active material and large porosity while containing a large amount of the active material in its voids, the active material can be effectively used. In a positive electrode in a lithium ion capacitor or a nonaqueous electrolyte secondary battery, the conductivity is normally increased by adding a conductive assistant. The use of the above-described metal porous body as the positive electrode current collector tends to ensure high conductivity although the amount of the conductive assistant added is reduced. Consequently, the rate characteristics and energy density (and capacity) of the battery can be effectively increased.

The specific surface area (BET specific surface area) of the metal porous body is, for example, 100 to 700 cm²/g, preferably 150 to 650 cm²/g, and still more preferably 200 to 600 cm²/g.

The porosity of the metal porous body is, for example, 40 to 99 vol %, preferably 60 to 98 vol %, and still more preferably 80 to 98 vol %. The mean pore size (mean size of the cell-like pores in communication with each other) in the three-dimensional network structure is, for example, 50 to 1000 μm, preferably 100 to 900 μm, and still inure preferably 350 to 900 μm. The mean pore size is smaller than the thickness Of the metal porous body (or electrode). It is noted that rolling deforms the skeleton of the metal porous body and changes the porosity and the mean pore size. The ranges of the porosity and the mean pore size are the ranges of the porosity and the mean pore size of the metal porous body before rolling (before filling with a mixture).

The metal (the metal for plating) that forms the positive electrode current collector for a lithium ion capacitor or a nonaqueous electrolyte secondary battery is, for example, at least one metal selected from aluminum, aluminum alloys, nickel, and nickel alloys. The metal (the metal for plating) that forms the negative electrode current collector for a lithium ion capacitor or a nonaqueous electrolyte secondary battery is at least one metal selected from copper, copper alloys, nickel, and nickel alloys. The same metals as those described above (e.g., copper, copper alloys) can also be used in an electrode collector for an electric double layer capacitor.

FIG. 7 is a cross-sectional schematic diagram illustrating a state in which voids of the metal porous body in FIG. 6 are filled with an electrode mixture.

The cell-like pores 101 are filled with an electrode mixture 104. The electrode mixture 104 is attached to the surface of the metal skeleton 102 to form an electrode mixture layer having a thickness wₘ. An empty space 102a having a width w_{f} is formed inside the skeleton 102 of the metal porous body. After the cell-like pores 101 are filled with the electrode mixture 104, the voids remain on the inner side of the electrode mixture layer in the cell-like pores 101. After the metal porous body is filled with the electrode mixture, the metal porous body is rolled in the thickness direction as desired to form an electrode. FIG. 7 illustrates a state before rolling. In the electrode obtained by rolling, the skeleton 102 is in a state of being slightly pressed in the thickness direction, and the voids on the inner side of the electrode mixture layer in the pores 101 and the empty space in the skeleton 102 are in a state of being pressed. After rolling the metal porous body, the voids on the inner side of the electrode mixture layer remain to some extent, which ensures high porosity of the electrode.

The positive electrode or negative electrode is formed by, for example, filling the voids in the metal porous body obtained as described above with an electrode mixture and optionally compressing the current collector in the thickness direction. The electrode mixture contains in active material as an essential component, and may further contain a conductive assistant and/or a binder as optional components.

The thickness wₘ of a mixture layer formed by filling the cell-like pores of the current collector with the mixture is, for example, 10 to 500 μm, preferably 40 to 250 μm, and still more preferably 100 to 200 μm. In order to ensure voids on the inner side of the mixture layer formed in the cell-like pores, the thickness wₘ of the mixture layer preferably corresponds to 5 to 40% of the mean pore size of the cell-like pores, and more preferably corresponds to 10 to 30%.

A material that intercalates and deintercalates alkali metal ions can be used as the positive electrode active material for a nonaqueous electrolyte secondary battery. Examples of such a material include metal chalcogen compounds (e.g., metal sulfides), metal oxides, alkali metal-containing transition metal oxides (e.g., lithium-containing transition metal oxides and sodium-containing transition metal oxides), and alkali metal-containing transition metal phosphates (e.g., iron phosphate having an olivine structure). These positive electrode active materials may be used alone or in combination of two or more.

A material that intercalates and deintercalates alkali metal ions, such as a lithium ion, can be used as a negative electrode active material for a lithium ion capacitor or a nonaqueous electrolyte secondary battery. Examples of such a material include carbon materials, spinel-type lithium titanium oxide, spinel-type sodium titanium oxide, silicon oxide, silicon alloys, tin oxide, and tin alloys. Examples of carbon materials include graphite, graphitizable carbon (soft carbon), and non-graphitizable carbon (hard carbon).

As a positive electrode active material (or a lithium ion capacitor, a first carbon material that adsorbs and desorbs anions can be used. As an active material for one electrode in an electric double layer capacitor, a second carbon material that adsorbs and desorbs organic cations can be used. As an active material for the other electrode, a third carbon material that adsorbs and desorbs anions can be used. Examples of the first to third carbon materials include carbon materials, such as activated carbon, graphite, graphitizable carbon (son carbon), and non-graphitizable carbon (hard carbon).

The type of conductive assistant is not limited. Examples of the conductive assistant include carbon blacks, such as acetylene black and Ketjenblack; conductive fibers, such as carbon fibers and metal fibers; and nanocarbons, such as carbon nanotubes. The amount of the conductive assistant is not limited. The amount of the conductive assistant is, for example, 0.1 to 15 parts by mass, and preferably 0.5 to 10 parts by mass with respect to 100 parts by mass of the active material.

The type of binder is not limited. Examples of the binder include fluororesins, such as polyvinylidene fluoride (PVDF) and polytetrafluoroethylene; chlorine-containing vinyl resins, such as polyvinyl chloride; polyolefin resins; rubber polymers, such as styrene-butadiene rubber; polyvinylpyrrolidone and polyvinyl alcohol; and polysaccharides, such as cellulose derivatives (e.g., cellulose ether), such as carboxymethyl cellulose, and xanthan gum. The amount of the binder is not limited. The amount of the hinder is, for example, 0.5 to 15 parts by mass, preferably 0.5 to 10 parts by mass, and still more preferably 0.7 to 8 parts by mass with respect to 100 parts by mass of the active material.

The thickness of the first electrode 18 and the second electrode 20 is 0.2 mm or more, preferably 0.5 mm or more, and more preferably 0.7 mm or more. The thickness of the first electrode 18 and the second electrode 20 is 5 mm or less, preferably 4.5 mm or less, and more preferably 4 mm or less or 3 mm or less.

These lower limits and upper limit can be freely combined. For example, the thickness of the first electrode 18 and the second electrode 20 may be 0.5 to 4.5 mm or 0.7 to 4 mm.

The separator 21 has ion permeability and is interposed between the first electrode 18 and the second electrode 20 to prevent a short circuit between these electrodes. The separator 21 has a porous structure and allows permeation of ions through the separator 21 by holding the electrolyte in fine pores of the porous structure. As the separator 21, a fine porous film, a non-woven fabric (including paper), or the like can be used. Examples of the material of the separator 21 include polyolefins such as polyethylene and polypropylene; polyesters, such as polyethylene terephthalate; polyamides; polyimides; cellulose; and glass fibers. The thickness of the separator 21 is, for example, about 10 to 100 μm.

An electrolyte for a lithium ion capacitor contains a salt of a lithium ion and an anion (first anion). Examples of the first anion include fluorine-containing acid anions (e.g., PF₆⁻, BF₄⁻), a chlorine-containing acid anion (ClO₄⁻), a bis(oxalato)borate anion (BC₄O₈⁻), a bissulfonylamide anion, and a trifluoromethanesulfonate ion (CF₃SO₃⁻).

An electrolyte for an electric double layer capacitor contains a salt of an organic cation and an anion second anion). Examples of the organic cation include a tetraethylammonium ion (TEA⁺), a triethylmonomethylammonium ion (TEMA⁺), a 1-ethyl-3-methyl imidazolium ion (EMI⁺), and an N-methyl-N-propylpyrrolidinium ion (MPPY⁻). Examples of the second anion include the same anions as those listed as the first anion.

An electrolyte for a nonaqueous electrolyte secondary battery contains a salt of an alkali metal ion and an anion (third anion). For example, an electrolyte for a lithium ion battery contains a salt of a lithium ion and an anion (third anion). An electrolyte for a sodium ion battery contains a salt a sodium ion and an anion (third anion). Examples of the third anion include the same anions as those listed as the first anion.

The electrolyte may also contain a nonionic solvent or water for dissolving the above salt or may contain a molten salt containing the above salt. Examples of the nonionic solvent include organic solvents, such as organic carbonates and lactones. When the electrolyte contains a molten salt, the salt (ionic substance composed of an anion and a cation) preferably accounts for 90 mass% or more of the electrolyte in order to improve heat resistance.

The cation that makes up the molten salt is preferably an organic cation. Examples of the organic cation include nitrogen-containing cations; sulfur-containing cations; and phosphorus-containing cations. The anion that makes up the molten salt is preferably a bissulfonylamide anion. Among bissulfonylamide anions, a bis(fluorosulfonyl)amide anion (FSA⁻) (N(SO₂F)₂⁻), a bis(trifluoromethylsulfonyl)amide anion (TFSA⁻) (N(SO₂CF₃)₂⁻), a (fluorosulfonyl)(trifluoromethylsulfonyl)amide anion (N(SO₂F) (SO₂CF₃)⁻), and the like are preferred.

Examples of nitrogen-containing cations include quaternary ammonium cations, pyrrolidinium cations, pyridinium cations, and imidazolium cations.

Examples of quaternary ammonium cations include tetraalkylammonium cations (e.g., tetra C₁₋₁₀ alkylammonium cations), such as a tetramethylammonium cation, an ethyltrimethylammonium cation, a hexyltrimethylammonium cation, a tetraethylammonium cation (TEA⁺), and a methyltriethylammonium cation (TEMA⁻).

Examples of pyrrolidinium cations include a 1,1-dimethylpyrrolidinium cation, a 1,1-diethylpyrrolidinium cation, a 1-ethyl-1-methylpyrrolidinium cation, a 1-methyl-1-propylpyrrolidinium cation (MPPY⁺), a 1-butyl-1-methylpyrrolidinium cation (MBPY⁺), and a 1-ethyl-1-propylpyrrolidinium cation.

Examples of pyridinium cations include 1-alkylpyridinium cations, such as a 1-methylpyridinium cation, a 1-ethylpyridinium cation, and a 1-propylpyridinium cation.

Examples of imidazolium cations include a 1,3-dimethylimidazolium cation, a 1-ethyl-3-methylimidazolium cation (EMI⁺), a 1-methyl-3-propylimidazolium cation, a 1-butyl-3-methylimidazolium cation (BMI⁺), a 1-ethyl-3-propylimidazolium cation, and a 1-butyl-3-ethylimidazolium cation.

Examples of sulfur-containing cations include tertiary sulfonium cations, for example, trialkylsulfonium cations (e.g., tri C₁₋₁₀ alkylsulfonium cations), such as a trimethylsulfonium cation, a trihexylsulfonium cation, and a dibutylethylsulfonium cation.

Examples of phosphorus-containing cations include quaternary phosphonium cations, for example, tetraalkylphosphonium cations (e.g., tetra C₁₋₁₀ alkylphosphonium cations), such as a tetramethylphosphonium cation, a tetraethylphosphonium cation, and a tetraoctylphosphonium cation; and alkyl(alkoxyalkyl)phosphonium cations (e.g., tri C₁₋₁₀ alkyl(C₁₋₅ alkoxy-C₁₋₅ alkyl)phosphonium cations), such as a triethyl(methoxymethyl)phosphonium cation, a diethylmethyl(methoxymethyl)phosphonium cation and a trihexyl(methoxyethyl)phosphonium cation.

The above description includes the following features.

### Appendix 1

An electricity storage device comprises:

an electrode group that includes a first electrode, a second electrode, and a separator electrically insulating the first electrode from the second electrode;

an electrolyte;

a case that accommodates the electrode group and the electrolyte and has an opening; and

a sealing plate that seals the opening of the case,

wherein

the sealing plate has a degassing valve,

the degassing valve has an easily breakable part, and

the easily breakable part has plural linear grooves.

### Appendix 2

The electricity storage device according to Appendix 1, wherein

the first electrode includes a first current collector having a sheet shape and a first active material carried by the first current collector,

the second electrode includes a second current collector having a sheet shape and a second active material carried by the second current collector, and

the first electrode and the second electrode are alternately stacked with the separator interposed therebetween.

### Appendix 3

The electricity storage device according to Appendix 1 or 2, wherein the easily breakable part has a circular shape or a substantially regular polygonal shape.

Examples of the shape of the easily breakable part include circle, ellipses, substantial polygons, substantially regular polygons, substantial rhombus, and substantial rectangles. In order to effectively reduce a variation in the operating pressure of the degassing valve and to make an aperture with a sufficient area in the easily breakable part, the easily breakable part preferably has a circular shape or a substantially regular polygon, and more preferably has a circular shape.

The term “substantial polygons” refers to polygons and shapes similar to polygons (e.g., polygons having rounded corners, and polygons in which part or all of the sides are curved). The term “substantially regular polygons” refers to regular polygons (e.g., square, regular hexagon, regular octagon) and shapes similar to regular polygons (e.g., regular polygons having rounded corners, and regular polygons in which part or all of the sides arc curved). The term “substantial rhombuses” refers to rhombuses and shapes similar to rhombuses (e.g., rhombuses having rounded corners, and rhombuses in which part or all of the sides are curved). The term “substantial rectangles” refers to rectangles and shapes similar to rectangles (e.g., rectangles having rounded corners, and rectangles in which part or all of the sides are curved).

### Appendix 4

The electricity storage device according to Appendix 3, wherein first ends of the grooves are located near the center of the easily breakable part.

### Appendix 5

The electricity storage device according to Appendix 4, wherein the first ends of the grooves meet at one point near the center of the easily breakable part.

The first ends of the grooves are located inside the easily breakable part. In order to effectively reduce a variation in the operating pressure of the degassing valve and to make an aperture with a sufficient area in the easily breakable part, the first ends of the grooves are preferably located near the center of the easily breakable part, more preferably meet at one point near the center of the easily breakable part, and still more preferably meet at the center of the easily breakable part.

The term “near the center” as used herein refers to, for example, the range within a fourth of the radius of the circle from the center of the easily breakable part, the range within an eighth of the minor axis of an ellipse from the center of the easily breakable part, the range within a fourth of the distance between the center of the easily breakable part and the sides of a substantial regular polygon from the center of the easily breakable part, the range within a fourth of the distance between the center of the easily breakable part and the sides of a substantial rhombus from the center of the easily breakable part, or the range within a fourth of the distance between the center of the easily breakable part and the long sides of a substantial rectangle from the center of the easily breakable part.

It is noted that the “distance between the center of the easily breakable part and the sides of a substantially regular polygon” is the shortest distance between the center of the easily breakable part and the sides of the substantially regular polygon (for a regular polygon, the length of the perpendicular from the center to the sides). Similarly, the “distance between the center of the easily breakable part and the sides of a substantial rhombus” is the shortest distance between the center of the easily breakable part and the sides of the substantial rhombus. The “distance between the center of the easily breakable part and the long sides of a substantial rectangle” is the shortest distance between the center of the easily breakable part and the long sides of the substantial rectangle.

### Appendix 6

The electricity storage device according to Appendix 5, wherein an angle formed by adjacent grooves among the grooves is (360/N×0.98)° to (360/N×1.02)° where N is the number of the grooves, the total angle formed by adjacent grooves is 360°, and the N is 3 or larger.

In order to effectively reduce a variation in the operating pressure of the degassing valve, all the angles formed by adjacent grooves are preferably the same or substantially the same.

### Appendix 7

The electricity storage device according to Appendix 5 or 6, wherein the number of the grooves is 3 or larger and 8 or smaller.

The number of the grooves can be 2, 3, 4, 5, or 6 or larger. In order to assuredly cause a break originating from any one of the grooves in the easily breakable part under a desired operating pressure when the degassing valve actually operates, the number of the grooves is preferably 3 or larger. In order to easily make an aperture with a sufficient area in the easily breakable part, the number of the grooves is preferably 8 or smaller, and more preferably 6 or smaller. In order to assuredly cause a break originating from any one of the grooves in the easily breakable part under a desired operating pressure and to make an aperture with a sufficient area in the easily breakable part when the degassing valve actually operates, the number of the grooves is particularly preferably 3.

In Appendixes 6 and 7, when the grooves each linearly extend beyond the intersection thereof, the number of the grooves is 2 (the angle formed by two grooves may be 180° when the intersection of the grooves considered as the apex of the angle).

### Appendix 8

An electricity storage device comprises:

an electrode group that includes a first electrode, a second electrode, and a separator electrically insulating the first electrode from the second electrode;

an electrolyte;

a case that accommodates the electrode group and the electrolyte and has an opening; and

a sealing plate that seals the opening of the case,

wherein

the first electrode includes a first current collector having a sheet shape and a first active material carried by the first current collector,

the second electrode includes a second current collector having a sheet shape and a second active material carried by the second current collector,

the first electrode and the second electrode are alternately stacked with the separator interposed therebetween,

the sealing plate has a degassing valve through which gas in the case is to be released to an outside when the pressure that the sealing plate receives from the gas in the case reaches a reference pressure,

the degassing valve has a circular easily breakable part,

the easily breakable part has a linear first groove, a linear second groove, and a linear third groove, and

first ends of the first groove, the second groove, and the third groove meet at a center of the easily breakable part.

### Appendix 9

The electricity storage device according to Appendix 8, wherein

the sealing plate contains aluminum or an aluminum alloy, and

the easily breakable part has a thickness DT of 50 to 250 μm.

### Appendix 10

The electricity storage device according to Appendix 8 or 9, wherein

the sealing plate contains aluminum or an aluminum alloy, and

the rated capacity is 1000 to 3000 mAh, and the easily breakable part has a radius R1 of 3 to 6 mm.

### Appendix 11

The electricity storage device according to any one of Appendixes 8 to 10, wherein

the sealing plate has a pair of parallel long sides and a pair of parallel short sides, and

the ratio α1, which is a ratio W2/W1 of a distance W2 between the pair of short sides to a distance W1 between the pair of long sides, is 5 to 15.

### Appendix 12

The electricity storage device according to any one of Appendixes 8 to 11, wherein the easily breakable part has, in a vicinity thereof, an annular break propagation preventing part for preventing a break of the easily breakable part around the easily breakable part when the easily breakable part breaks.

a residual thickness D4 of the sealing plate in the break propagation preventing part is larger than a residual thickness D1 of the easily breakable part at the first groove, a residual thickness D2 of the easily breakable part at the second groove, and a residual thickness D3 of the easily breakable part at the third groove.

### Appendix 13

The electricity storage device according to any one of Appendixes 1 to 12, wherein

the first current collector includes a first metal porous body, and

the first metal porous body is a metal porous body having a three-dimensional network structure, and

the metal porous body having a three-dimensional network structure contains aluminum.

### Appendix 14

The electricity storage device according to any one of Appendixes 1 to 13, wherein

the second current collector includes a second metal porous body, and

the second metal porous body is a metal porous body having a three-dimensional network structure, and

the metal porous body having a three-dimensional network structure contains copper.

### INDUSTRIAL APPLICABILITY

The present invention can be widely applied to electricity storage devices, such as lithium ion batteries, sodium ion batteries, lithium ion capacitors, and electric double layer capacitors.

### REFERENCE SIGNS LIST

10 Electricity storage device

12 Electrode group

14 Case

16 Sealing plate

18 First electrode

20 Second electrode

21 Separator

22 First current collector

24 Second current collector

26 First connection part

28 Second connection part

30 First conductive spacer

32 Second conductive spacer

34 First fastening member

36, 37 Through-hole

38 Second fastening member

40 First external terminal

42 Second external terminal

44 Degassing valve

46 Injection hole

48 Plug

62 First lead

64 Second lead

65 Break propagation preventing part

66 Easily breakable part

68A First groove

68B Second groove

68C Third groove

101 Pore

102 Metal skeleton

102a Empty space

103 Opening

104 Electrode mixture

1. An electricity storage device comprising:
an electrode group that includes a first electrode, a second electrode, and a separator electrically insulating the first electrode from the second electrode;
an electrolyte;
a case that accommodates the electrode group and the electrolyte and has an opening; and
a sealing plate that seals the opening of the case,
wherein
the first electrode includes a first current collector having a sheet shape and a first active material carried by the first current collector,
the second electrode includes a second current collector having a sheet shape and a second active material carried by the second current collector,
the first electrode and the second electrode are alternately stacked with the separator interposed therebetween,
the sealing plate has a degassing valve through which gas in the case is to be released to an outside when a pressure inside the case reaches a reference pressure,
the degassing valve has a circular easily breakable part,
the easily breakable part has a linear first groove, a linear second groove, and a linear third groove, and
first ends of the first groove, the second groove, and the third groove meet at a center of the easily breakable part.

2. The electricity storage device according to claim 1, wherein ratios L1/R1, L2/R1, and L3/R1, which are ratios of a length L1 of the first groove, a length L2 of the second groove, and a length L3 of the third groove to a radius R1 of the easily breakable part, are 0.98 to 1.02.

3. The electricity storage device according to claim 1, wherein a ratio D1/D2 of a residual thickness D1 of the easily breakable part at the first groove to a residual thickness D2 of the easily breakable part at the second groove, a ratio D2/D3 of the residual thickness D2 of the easily breakable part at the second groove to a residual thickness D3 of the easily breakable part at the third groove, and a ratio D3/D1 of the residual thickness D3 of the easily breakable part at the third groove to the residual thickness D1 of the easily breakable part at the first groove are 0.98 to 1.02.

4. The electricity storage device according to claim 1, wherein an obtuse angle θ1 formed by the first groove and the second groove, an obtuse angle θ2 formed by the second groove and the third groove, and an obtuse angle θ3 formed by the third groove and the first groove are (120×0.98)° to (120×1.02)°, and a sum of the θ1, the θ2, and the θ3 is 360°.

5. The electricity storage device according to claim 1, wherein the sealing plate has a pair of parallel long sides and a pair of parallel short sides, and any one of the first groove, the second groove, and the third groove is parallel to the pair of long sides and is located in the middle between the pair of long sides.

6. The electricity storage device according to claim 1, wherein the degassing valve has, around the easily breakable part, a break propagation preventing part for preventing a break of the easily breakable part from propagating around the easily breakable part when the easily breakable part breaks.

7. The electricity storage device according to claim 6, wherein
the sealing plate has a pair of parallel long sides and a pair of parallel short sides and has a circular injection hole for injecting the electrolyte into the case after sealing the opening of the case,
a center of the easily breakable part is located in the middle between the pair of long sides of the sealing plate and is located in the middle between the pair of short sides, and
a ratio LS/DS of a shortest distance LS between the break propagation preventing part and the injection hole to a thickness DS of the sealing plate is 5 to 12.

8. The electricity storage device according to claim 1, wherein
the electrolyte contains a salt of a lithium ion and an anion, and
any one of the first active material and the second active material is a first material that intercalates and deintercalates the lithium ion, and the other active material is a second material that adsorbs and desorbs the anion.
